(19) United States
(12) Patent Application Publication
(10) Pub. No.: US 2001/0021404 A1
(43) Pub. Date: Sep. 13, 2001

(54) Controlled release encapsulated substances

(76) Inventors: Jens Uhlemann, Holzminden (DE); Birgit Schleifenbaum, Hoxter (DE)

Correspondence Address: BAYER CORPORATION, PATENT DEPARTMENT, 100 BAYER ROAD, PITTSBURGH, PA, 15205, US

(21) Appl. No.: 09/800,937

(22) Filed: Mar. 7, 2001

(30) Foreign Application Priority Data
Mar. 13, 2000 (DE) 10012199.3

(51) Int. Cl. A23L 1/0534

(52) U.S. Cl. 426/89; 426/578; 426/650; 424/494; 424/495

(57) ABSTRACT

Novel encapsulated substances which remain largely encapsulated in aqueous medium during a heat-treatment and only dissolve during a subsequent cooling phase can be prepared by processes for the preparation of spherical cores and subsequent coating with one or more hydrophobic shells and a shell of modified cellulose.

### FIELD OF THE INVENTION

The invention relates to encapsulated substances, which remain largely encapsulated in an aqueous medium during heat-treatment and only dissolve during a subsequent cooling phase.

### BACKGROUND OF THE INVENTION

The encapsulated substances, e.g. flavorings and fragrances, are complex liquid mixtures of volatile components. In the manufacturing preparation of flavored foods and perfumed products there is a need to control the release of flavorings or fragrances in order to avoid losses.

Particularly, in the case of hydrous foods, which are heated to high temperatures, protection of the flavoring is a technological requirement. Here, considerable losses in flavoring arise as a result of the volatility of the flavoring components upon heating. In addition, in the case of flavoring compositions, shifts in the flavoring profile can arise as a result of the differing rates of loss of the individual components. Conversion of the flavoring to the liquid during the heating and high-temperature phase in a food processing process must, therefore, be avoided. Encapsulation of the flavoring is suitable for this purpose. This flavoring capsule should then ideally dissolve in a controlled manner during the cooling phase and thus, also release the flavoring in a controlled manner.

The deposition of coatings on particles for adjusting the solubility or release behavior and for protecting encapsulated substances is known (Lebensm.-Wiss. u. -Technol. 24, 289-297 (1991)); a whole series of suitable coating materials are listed here, including fats, waxes, hydrocolloids, including, for example, modified celluloses, and proteins.

WO 97/16078 describes flavoring and fragrance granulates which can be coated by a protective skin. Modified cellulose is inter alia specified as a possible coating. The granulates, themselves, are inhomogeneous and comprise a carrier material and a flavoring incorporated into a film-forming agent. The goal of this invention is to produce a granulate containing as little dust as possible. The resulting particles have an irregular shape and an uncontrollable release behavior of the ingredients.

A reduction in the release rate of encapsulated flavorings using a hydrophilic core in aqueous systems is usually achieved by applying coatings. (“Microencapsulation and the Food Industry” (Lebensm.-Wiss. u. -Technol. 24, 289-297 (1991)).

A reduction in the water solubility can be achieved by applying hydrophobic coatings, such as, for example, fats or waxes, provided the temperature is below the melting range of these coatings.

Certain modified celluloses are suitable as a protective coating for lowering the water solubility at relatively high temperatures. They are characterized by a reversible formation, unique to the group of hydrocolloids, of a solid gel in water at elevated temperatures. The viscosity of these gels increases greatly at high temperatures (above the substance-specific flock point, i.e. the temperature above which the solid high-viscosity gels are formed) and then decreases again during cooling. Moreover, the reversibility of the gel formation distinguishes the modified celluloses markedly from the behavior of protein gels, which are able to gel even at high temperature, but whose gels do not redissolve upon cooling.

This viscosity and temperature behavior, which is an inverse relationship when compared with other gel systems, above the flock point and the reversibility of the gel formation of certain modified celluloses, is referred to as “reversible thermal gelation”. (Edible Films and Coatings: A Review, Food Technology, December 1986, 47 to 59).

The exploitation of the reversible thermogelation of methylcellulose or hydroxy-propylcellulose during use as a protective matrix for temperature-sensitive substances is known per se. Thus, for example, according to WO 92/11084, methylcellulose is used in a capsule matrix for the sweetener aspartame, which is unstable in hydrous media at high temperatures. The stability of the sweetener in bakery goods can thereby be increased.

WO 98/49910 describes the encapsulation of different types of materials having a diameter of from 30 to 1000 μm. The materials may be medicaments, cosmetic articles, preservatives, foods, such as nuts, raisins, croutons or pieces of bread, growth regulators, dyes, flavorings, pesticides or herbicides. First, these materials are coated with a hydrophobic film and then with a layer which has a temperature-dependent reversible dissolution behavior. This layer can consist of cellulose derivatives or other polymers. The inner hydrophobic film consists, for example, of fats, paraffin or water. It is also possible for another outer hydrophobic layer to be placed around the layer with reversible dissolution behavior. The material to be encapsulated can assume various forms; it is preferably in tablet form.

### SUMMARY OF THE INVENTION

The objective of the present invention is to provide encapsulated substances, which are largely protected by the encapsulation in aqueous medium both during heating and also during the hold-time at high temperatures, and are then released in a controlled manner during cooling. The release rate in the cooling phase should be controllable in a targeted manner as a function of time and temperature up to complete cold-water solubility. In addition, the release rates for different substances in mixtures should be approximately equal in order to prevent an undesired shifting of the release profile. By delaying the release at high temperatures, the aim was to reduce substance losses.

We have now found encapsulated substances comprising a core, one or more hydrophobic layers and a layer of modified cellulose which exhibits reversible gel formation when the temperature is increased, which are characterized in that the cores have a largely spherical shape with high sphericity.

### DETAILED DESCRIPTION OF THE INVENTION

The sphericity can be measured, for example, according to the criterion given by H. Wadell (“Volume, Shape and Roundness of Rock Particles”; Journal of Geology 40 (1932) 443-451):

$$Ψ = \frac{{x}_{V}^{2}}{{x}_{S}^{2}}$$

using the equivalent particle diameter in terms of volume x_{V} and the equivalent diameter in terms of surface area x_{S}. According to the definition, the sphericity can assume numerical values>0 to 1. Cores preferred according to the present invention have a sphericity of>0.7, more preferably of>0.9.

The cores have a smooth surface without corners and edges. The corners and edges lead to increased abrasion, which establishes itself as faults in the layers. Furthermore, the corners and edges lead to irregular deposition of the layers.

The core generally has a diameter in the range from 10 to 5000 μm, preferably from 200 to 2000 μm.

The encapsulated substances according to the present invention have a uniform coating with one or more hydrophobic layers and the layer of modified cellulose. As a result, it is possible to protect the substance during heating at temperatures to greater than the flock point of the modified cellulose, and then to release it in a targeted manner during cooling. Encapsulated substances with irregular layer thickness during coating, release the substances over a wide temperature range. A uniform layer thickness can preferably be achieved for cores having high sphericity (>0.7).

Substances, which are normally encapsulated according to the present invention, decompose in a warm, aqueous environment and are readily volatile. Examples which may be mentioned are: flavorings and fragrances, such as strawberry flavoring, foods such as soup powders/sauce powders, dessert powders, pasteurized or sterilized finished beverages, pulverulent medicaments, such as hot instant formulations, commodities, such as detergents, additives, such as sweeteners, dyes, crop protection agents, such as pesticides or herbicides. According to the present invention, preference is given to encapsulating flavorings and/or fragrances, more preferably, flavorings.

Hydrophobic layers for coating the cores are known from WO 98/49910. They generally have a melting point in the range from 20 to 90.

Examples of materials for the hydrophobic layers which may be mentioned are: hydrogenated fats, coconut fat, cocoa butter, monoglycerides and diglycerides, fatty acids, such as lauric acid, palmitic acid and stearic acid, lecithin, and waxes, and mixtures of the components.

According to the present invention, the encapsulated substances comprise one or more, preferably one or two, hydrophobic layers. A hydrophobic layer can be placed directly around the core. A further hydrophobic layer can be applied as an outer layer next to the layer of modified cellulose.

Materials which are preferred for the outer hydrophobic layer are those whose melting temperature is identical to or above the LCST temperature (lower critical solution temperature as known from WO 98/49910) of the layer of modified cellulose and at the same time, is below the maximum processing temperature if the capsules are used, for example, in a food manufacturing process.

Materials which are preferred for the inner hydrophobic layer are those whose melting temperature is below the LCST temperature (lower critical solution temperature as known from WO 98/49910) of the layer of modified cellulose and at the same time, is below the use temperature in accordance with directions, for example in the case of consumption.

Modified cellulose for the substances according to the present invention means modified celluloses, which can form thermoreversible gels. Preference is given here to methylcellulose, hydroxypropylcellulose, hydroxypropylmethylcellulose, ethylmethylcellulose, ethylcellulose or mixtures thereof.

Thermoreversible gels cannot be formed with all “modified celluloses”. Gels other than the “modified celluloses” according to the present invention, such as, for example, carboxymethylcellulose, do not behave in the desired manner.

The cellulose for the substances encapsulated according to the present invention forms a film, which has high viscosity even at high temperatures in aqueous media and represents a diffusion barrier for the substances. Upon gradual subsequent cooling, the cellulose gel layer exhibits increased swellability and a controllable reduction in viscosity until complete residue-free solubility. As a result, the encapsulated substance can be released linearly and as a function of time/temperature. The functioning mechanism of the coating (delay rate) can be optimally matched to the respective application requirements.

The modified cellulose forms a coating of the substance cores. The diffusion of the substance through the shell layer and thus, the release thereof can be controlled by the choice of cellulose having the specific flock point, and by the thickness of the shell layer. According to the present invention, modified celluloses are preferably chosen whose flock point is below the maximum processing temperature, but above the consumption temperature in accordance with the instructions.

The encapsulated substances according to the present invention can comprise 1 to 50% by weight, preferably 2 to 20% by weight, most preferably 5 to 10% by weight, of modified cellulose. The amount of cellulose in each case determines the layer thickness and controls the release rates for the substances: the higher the cellulose content, the slower the release.

We have found a process for the preparation of encapsulated substances comprising a core, one or more hydrophobic layers and a layer of modified cellulose which exhibits reversible gel formation when the temperature is increased, which is characterized in that spherical cores are coated in a fluidized bed with hydrophobic layers and a layer of modified cellulose.

If the substances are in powder form and can be formed to give spherical particles, they can be encapsulated in pure form. Preferably, in the case of liquids, they are bonded with hydrophilic carriers, such as gum arabic or dextrins, such as maltodextrin.

Liquids can be converted into solid cores by a variety of encapsulation processes. The cores according to the present invention having high sphericity are preferably prepared by fluidized-bed spray granulation, such as, for example, in accordance with EP 163 836 or EP A 070 719, by processes for the preparation of soft gelatin capsules by the drip-feed method and by melt extrusion processes with subsequent shaping to give spheres. The preparation of these cores is known per se. According to the present invention, the continuous method of preparation of the particles in an apparatus as in EP A 0 163 836 is preferred.

More preference is given to the preparation by continuous fluidized-bed spray granulation.

Following the step of core formation, a hydrophobic layer of, for example, fat or wax, can be applied. In the case of hydrophilic cores, this inner hydrophobic layer is necessary to prevent migration of hydrophilic substances from the core.

For the coating with films of uniform defined layer thickness, common coating processes are used. For this purpose, apparatuses known per se, preferably fluidized-bed apparatuses (top spray coater, bottom spray coater, Wurster coater), are used.

Fats or waxes of the hydrophobic coatings are melted prior to application and sprayed as melts.

Solvents, which can be used for the hydrophilic spray solution containing modified celluloses, are, for example, water or water/ethanol mixtures. Said modified celluloses are prepared in a concentration between 0% and 25%, preferably between 1% and 15%, in the spray solution. Preferably, for the application of coatings, modified celluloses with a degree of etherification, which give the spray solution only a low viscosity, are chosen.

Suitable inlet-air temperatures in the case of coatings with the modified celluloses in the fluidized bed are in the range from 50° C. to 140° C. Suitable exit-air temperatures in the case of coating in the fluidized bed are in the range from 30° C to 100° C. Suitable inlet-air temperatures in the case of coating with the hydrophobic substances in the fluidized bed are below the melting point thereof in the range from 0° C. to 100° C. Suitable exit-air temperatures in the case of coating in the fluidized bed are in the range from 20° C. to 40° C.

The layer thickness is 1 to 200 μm, preferably 2 to 100 μm, more preferably 5 to 50 μm.

The layer thickness is adjusted by the amount of sprayed-on solution.

Depending on the application, other substances or substance mixtures, for example, other hydrocolloids, sugars and also plasticizers, such as e.g. polyethylene glycol, and also customary additives, such as e.g. food dyes, can also be added to the spray solution.

The present invention further includes a process for enriching foods with flavorings encapsulated according to the present invention. Examples of foods which contain the flavorings encapsulated according to the present invention, which may be mentioned, are: instant sauce powders, ready-to-use sauces, pasteurized beverages, chewy sweets, waffles.

The present invention further includes a process for the preparation of perfumed commodities, such as, for example, detergents.

The processes are are characterized in that the above-described encapsulated flavorings and/or fragrances are added to the foods or the commodities.

During or after the addition of the encapsulated flavorings and/or fragrances according to the present invention, the foods are preferably heated to a temperature above the flock point of the modified cellulose and then cooled.

As a result of the particular release behavior of the encapsulated substances according to the present invention, it is possible to achieve new grades of their use forms. Thus, for example, heating is possible without considerable loss of or change in the encapsulated substance.

Conversely, particularly during cooling of the foods, the desired and defined release of the encapsulated substances occurs, the progress of which over time can be controlled by the type of encapsulation.

Since the various individual flavoring components are released at the same rate, and their quantitative ratio relative to one another therefore remains constant, no undesired shifts in flavoring profile arise in the case of mixtures, such as, for example, flavorings.

### EXAMPLES

### Example 1

### (tomato granules)

A solution consisting of 44% by weight of water, 1 1% by weight of tomato flavoring, 13% by weight of gum arabic and 32% by weight of hydrolyzed starch (maltodextrin DE 15-19) is granulated in a granulating apparatus of the type described in DE-A 38 08 277 and EP 163 836 (having the following features: diameter of inflow plate: 225 mm, spray nozzle: two-substance nozzle; screening discharge: zigzag screen; filter: internal bag filter). The solution is sprayed into the fluidized-bed granulator at a temperature of 32° C. Nitrogen is blown in at an amount of 140 kg/h to fluidize the bed contents. The inlet temperature of the fluidizing gas is 140° C. The temperature of the exit gas is 76° C. The screening gas which is introduced is likewise nitrogen in an amount of 15 kg/h at a temperature of 50° C. The content of the fluidized bed is about 1700 g. The granulation capacity is about 2.8 kg per hour. This gives free flowing granules having an average particle diameter of 1 mm and a bulk density of 600 g/l. The granules are round and have a smooth surface. Because of the constant pressure loss of the filter and the fact that the bed contents likewise remain constant, it is assumed that the conditions with regard to the granulation process are stationary.

In the same apparatus, the granules produced previously were coated with the fat Witocan (melting range 40-44° C.); 400 g are introduced as the initial bed. By increasing the amount of screening gas to 23 kg/h at 25° C., no material is discharged, i.e. the coating takes place in the batch operation. The fat is melted and sprayed at a temperature of 74° C. into the fluidized-bed granulator. The temperature of the atomizing gas is 70° C. Nitrogen is blown in at an amount of 100 kg/h to fluidize the bed contents. The inlet temperature of the cooled fluidizing gas is 16° C. The temperature of the exit gas is 28° C. This gives free flowing granules.

In the same apparatus, the granules coated with fat are introduced as the initial bed. A solution of 2.0% by weight of low-viscosity methylcellulose (viscosity of a 2% strength aqueous solution at 20° C.: 400 cP) in water is prepared. The flock point of this methylcellulose is 50-55° C.

The methylcellulose solution is sprayed into the fluidized-bed granulator at a temperature of 22° C. The temperature of the atomizing gas is 30° C. Nitrogen is blown in in an amount of 120 kg/h to fluidize the bed contents. The inlet temperature of the fluidizing gas is 140° C. The temperature of the exit gas is 81° C.

In the same apparatus the granules produced previously were again coated with the fat Revel A (from Loders Croklaan, rise point 59° C.); 400 g are introduced as the initial bed. By increasing the amount of screening gas to 23 kg/h at 25° C., no material is discharged, i.e. coating takes place in the batch operation. The fat is melted and sprayed into the fluidized-bed granulator at a temperature of 74° C. The temperature of the atomizing gas is 70° C. Nitrogen is blown in in an amount of 100 kg/h to fluidize the bed contents. The inlet temperature of the cooled fluidizing gas is 16° C. The temperature of the exit gas is 28° C. This gives free flowing granules.

The solid particles are round. The thin, very uniform methylcellulose coating is 5% by weight, based on the weight of granules. The granules are round. SEM images of the fracture surfaces reveal a largely uniform coating of the granules with the fat.

### Example 2

### Heat-preserved liquid tomato sauce

A liquid sauce is flavored with tomato flavoring particles which have been coated with an inner layer of fat, a subsequent layer of methylcellulose, and an outer layer of fat. For preservation purposes, the sauce is heated for 10 minutes starting from room temperature to 80° C. to 100° C. and then cooled in the sealed packaging.

Advantages

The loss of volatile flavor components during heating is reduced. The flavoring is only fully released during cooling of the sauce in the sealed vessel.

During the heating phase, at temperatures below the melting range, of the outer shell of fat the flavoring remains enclosed and protected within the particles. As the temperature increases further, the outer hydrophobic shell melts when the melting temperature is reached. Since the melting range of the outer shell is chosen to be higher than the flock point of the layer of modified celluloses, the flavoring remains enclosed as before. During the cooling phase, the layer of modified celluloses redissolves. Provided the temperature is still above the melting range of the inner hydrophobic layer, this layer melts, finally freeing the hydrophilic core, which then dissolves in the aqueous matrix and releases the flavoring.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Encapsulated substances comprising a core, at least one hydrophobic layer and also a layer of modified cellulose having reversible gel formation when the temperature is increased, wherein said core is spherical in shape.

2. Encapsulated substances according to claim 1, wherein said cores have a sphericity of from 0.7 to 1.0.

3. Encapsulated substances according to claim 1, wherein said core additionally comprises hydrophilic carriers.

4. Encapsulated substances according to claim 1, wherein said core is prepared by fluidized-bed spray granulation.

5. Encapsulated substances according to claim 1, wherein said core is prepared by melt extrusion.

6. Encapsulated substances according to claim 1, wherein said core is prepared by drip-feed process for the preparation of soft gelatin capsules.

7. Encapsulated substances according to claim 1, wherein said core is coated with an inner hydrophobic layer and a second layer of modified cellulose which has reversible gel formation when the temperature is increased.

8. Encapsulated substances according to claim 1, wherein said core is coated with an inner hydrophobic layer, a second layer of modified cellulose which has reversible gel formation when the temperature is increased, and an outer hydrophobic layer.

9. A process for the preparation of encapsulated substances comprising a core, wherein said core is spherical in shape, one or more hydrophobic layers and a layer of modified cellulose having reversible gel formation when the temperature is increased, comprising the step of coating said core in a fluidized bed with at least one hydrophobic layer and a layer of modified cellulose.

10. A process according to claim 9, wherein said core is first coated with a hydrophobic layer and then with a layer of modified cellulose.

11. A process according to claim 9, wherein said core is first coated with a hydrophobic layer, then with a layer of modified cellulose, and subsequently with a hydrophobic layer.

12. A food product comprising an encapsulated substance comprising a core, at least one hydrophobic layer and also a layer of modified cellulose having reversible gel formation when the temperature is increased, wherein said core is spherical in shape.

13. A food product according to claim 12, wherein said food product is selected from group consisting of an instant sauce powder, ready-to-use sauces, waffles and bakery goods.

14. A perfumed commodity comprising an encapsulated substance comprising a core, at least one hydrophobic layer and also a layer of modified cellulose having reversible gel formation when the temperature is increased, wherein said core is spherical in shape.

15. A perfumed commodity according to claim 14, wherein said perfumed commodity is a detergent.

16. A beverage product comprising an encapsulated substance comprising a core, at least one hydrophobic layer and also a layer of modified cellulose having reversible gel formation when the temperature is increased, wherein said core is spherical in shape.

17. A beverage product according to claim 16, wherein said beverage product is a pasteurized drink.

18. A confectionary product comprising an encapsulated substance comprising a core, at least one hydrophobic layer and also a layer of modified cellulose having reversible gel formation when the temperature is increased, wherein said core is spherical in shape.

19. A confectionary product according to claim 18, wherein said confectionary product is a chewy sweet.
